(19) United States
(12) Patent Application Publication
(10) Pub. No.: US 2026/0278455 A1
(43) Pub. Date: Sep. 17, 2026

(54) MODEL UNLEARNING FOR MACHINE LEARNING MODELS BY DELINEATING UNDERLYING DATA

(71) Applicant: International Business Machines Corporation, Armonk, NY (US)

(72) Inventors: Adam Lee Griffin, Cohasset, MN (US); Balaji Muthusamy Pandurangan, Amstelveen (NL); Vivek Soni, Pune (IN)

(21) Appl. No.: 19/081,089

(22) Filed: Mar. 17, 2025

(51) Int. Cl. G06N 20/00; G06F 16/23

(52) U.S. Cl. CPC G06N 20/00; G06F 16/23

(57) ABSTRACT

A computer-implemented method is provided. A processor set identifies a dataset for model learning for a number of machine learning models. The processor set delineates a subset of data in the dataset. Data entries from the subset of data are relevant to context of subject matter to be removed from the model learning for the number of machine learning models. The processor set labels a portion of data from the subset of data. Data entries from the portion of data are associated with metric scores that indicate removal of the data will not prevent the number of machine learning models from performing tasks. The processor set modifies the portion of data from the dataset to form an updated dataset. The portion of data from the dataset is not used for the model learning for the number of machine learning models.

### BACKGROUND

The disclosure relates generally to model unlearning for machine learning models.

Model unlearning refers to the process of selectively removing specific data or learned patterns from a machine learning model. Unlike traditional model updates that refine or expand the knowledge of a machine learning model, model unlearning focuses on selectively erasing the impact of certain data without retraining the entire model from scratch. This process ensures that the model no longer relies on removed data when making future predictions.

As artificial intelligence (AI) and machine learning models continue to be widely used, the ability to modify and refine machine learning models efficiently becomes more important. Model unlearning helps to make artificial intelligence more adaptable. Specifically, model unlearning can help to update models when certain information becomes irrelevant, outdated, or incorrect.

### SUMMARY

According to one illustrative embodiment, a computer-implemented method is provided. A processor set identifies a dataset for model learning for a number of machine learning models. The processor set delineates a subset of data in the dataset. Data entries from the subset of data are relevant to context of subject matter to be removed from the model learning for the number of machine learning models. The processor set labels a portion of data from the subset of data. Data entries from the portion of data are associated with metric scores that indicate removal of the data will not prevent the number of machine learning models from performing tasks. The processor set modifies the portion of data from the dataset to form an updated dataset. The portion of data from the dataset is not used for the model learning for the number of machine learning models. According to other illustrative embodiments, a computer system and a computer program product are also provided.

### BRIEF DESCRIPTION OF THE DRAWINGS

FIG. 1 is a pictorial representation of a computing environment in which illustrative embodiments may be implemented;

FIG. 2 is an illustration of a block diagram of a model management environment in accordance with an illustrative embodiment;

FIG. 3 is an illustration of positional mapping in accordance with an illustrative embodiment;

FIG. 4 is an illustration of modification of data in accordance with an illustrative embodiment;

FIG. 5 is a flowchart of a process for model unlearning in accordance with an illustrative embodiment;

FIG. 6 is a flowchart of a process for model learning using an updated dataset in accordance with an illustrative embodiment;

FIG. 7 is a flowchart of a process for retraining machine learning models in accordance with an illustrative embodiment;

FIG. 8 is a flowchart of a process for masking data in accordance with an illustrative embodiment; and

FIG. 9 is a block diagram of a data processing system in accordance with an illustrative embodiment.

### DETAILED DESCRIPTION

A computer implemented method is provided. A processor set identifies a dataset for model learning for a number of machine learning models. The processor set delineates a subset of data in the dataset. Data entries from the subset of data are relevant to context of subject matter to be removed from the model learning for the number of machine learning models. The processor set labels a portion of data from the subset of data. Data entries from the portion of data are associated with metric scores that indicate removal of the data will not prevent the number of machine learning models from performing tasks. The processor set modifies the portion of data from the dataset to form an updated dataset. The portion of data from the dataset is not used for the model learning for the number of machine learning models. As a result, the illustrative embodiments provide a technical effect of efficiently performing model unlearning for the number of machine learning models by delineating data in the dataset to avoid complete retraining of the number of machine learning models from scratch.

In the illustrative embodiments, the metric scores associated with the portion of data are calculated using a set of statistical metrics using at least one of Density-Based Spatial Clustering of Applications with Noise (DBSCAN), XG-Boost, and K-means. As a result, the illustrative embodiments provide a technical effect of using the most suitable algorithms for calculating metric scores to determine if removal of data will prevent the number of machine learning models from performing tasks.

In the illustrative embodiments, the processor set identifies a second portion of data from the subset of data. Data entries from the second portion of data are associated with metric scores that indicate removal of the data will prevent the number of machine learning models from performing tasks. The processor set generates pseudo representations for the second subset of data. The pseudo representations enable the number of machine learning models to perform tasks via the model learning. The processor set replaces the second subset of data in the dataset with the pseudo representations to form the updated dataset. The processor set performs the model learning for the number of machine learning models using the updated dataset. As a result, the illustrative embodiments provide a technical effect of using pseudo representations to replace data in the dataset such that no data is required to be removed for model unlearning for the number of machine learning models.

In the illustrative embodiments, the processor set retrains the number of machine learning models using the updated dataset. As a result, the illustrative embodiments provide a technical effect of model unlearning by retraining the number of machine learning models using the updated dataset to avoid complete retraining of the number of machine learning models from scratch.

In the illustrative embodiments, as part of modifying the portion of data from the dataset to form an updated dataset, the processor set masks the portion of data from the dataset such that the portion of data is inaccessible to the number of machine learning models during model learning. As a result, the illustrative embodiments provide a technical effect of efficiently labelling the portion of data to ensure the portion of data is inaccessible to the number of machine learning models during model learning.

In the illustrative embodiments, the context of subject matter to be removed from the model learning for the number of machine learning models is determined based on content of a user request. As a result, the illustrative embodiments provide a technical effect of providing directed model unlearning based on the content of a user request.

In the illustrative embodiments, the context of subject matter to be removed from the model learning for the number of machine learning models is determined based on chronological information or security information associated with the subset of data in the dataset. As a result, the illustrative embodiments provide a technical effect of performing model unlearning for the number of machine learning models such that the number of machine learning models are able to provide up to date outputs that are in compliance with security measures.

A computer system includes a processor set, a set of one or more computer-readable storage media, and program instructions, stored in the set of one or more computer-readable storage media, to cause the processor set to perform the following computer operations. The processor set identifies a dataset for model learning for a number of machine learning models. The processor set delineates a subset of data in the dataset. Data entries from the subset of data are relevant to context of subject matter to be removed from the model learning for the number of machine learning models. The processor set labels a portion of data from the subset of data. Data entries from the portion of data are associated with metric scores that indicate removal of the data will not prevent the number of machine learning models from performing tasks. The processor set modifies the portion of data from the dataset to form an updated dataset. The portion of data from the dataset is not used for the model learning for the number of machine learning models. As a result, the illustrative embodiments provide a technical effect of efficiently performing model unlearning for the number of machine learning models by delineating data in the dataset to avoid complete retraining of the number of machine learning models from scratch.

In the illustrative embodiments, the metric scores associated with the portion of data are calculated using a set of statistical metrics using at least one of Density-Based Spatial Clustering of Applications with Noise (DBSCAN), XG-Boost, and K-means. As a result, the illustrative embodiments provide a technical effect of using most suitable algorithms for calculating metric scores to determine if removal of data will prevent the number of machine learning models from performing tasks.

In the illustrative embodiments, the processor set further executes the program instructions to identify a second portion of data from the subset of data. Data entries from the second portion of data are associated with metric scores that indicate removal of the data will prevent the number of machine learning models from performing tasks. The processor set further executes the program instructions to generate pseudo representations for the second subset of data. The pseudo representations enable the number of machine learning models to perform tasks via the model learning. The processor set further executes the program instructions to replace the second subset of data in the dataset with the pseudo representations to form the updated dataset. The processor set further executes the program instructions to perform the model learning for the number of machine learning models using the updated dataset. As a result, the illustrative embodiments provide a technical effect of using pseudo representations to replace data in the dataset such that no data is required to be removed for model unlearning for the number of machine learning models.

In the illustrative embodiments, the processor set further executes the program instructions to retrain the number of machine learning models using the updated dataset. As a result, the illustrative embodiments provide a technical effect of model unlearning by retraining the number of machine learning models using the updated dataset to avoid complete retraining of the number of machine learning models from scratch.

In the illustrative embodiments, as part of modifying the portion of data from the dataset to form an updated dataset, the processor set further executes the program instructions to mask the portion of data from the dataset such that the portion of data is inaccessible to the number of machine learning models during model learning. As a result, the illustrative embodiments provide a technical effect of efficiently labelling the portion of data to ensure the portion of data is inaccessible to the number of machine learning models during model learning.

In the illustrative embodiments, the context of subject matter to be removed from the model learning for the number of machine learning models is determined based on content of a user request. As a result, the illustrative embodiments provide a technical effect of providing directed model unlearning based on content of a user request.

In the illustrative embodiments, the context of subject matter to be removed from the model learning for the number of machine learning models is determined based on chronological information or security information associated with the subset of data in the dataset. As a result, the illustrative embodiments provide a technical effect of performing model unlearning for the number of machine learning models such that the number of machine learning models are able to provide up to date outputs that are in compliance with security measures.

In the illustrative embodiments, a computer program product is provided. The computer program product includes a set of one or more computer-readable storage media and program instructions, stored in the set of one or more computer-readable storage media, for causing a processor set to perform the following computer operations. The program instructions are executable by a computer system to identify a dataset for model learning for a number of machine learning models. The program instructions are executable by a computer system to delineate a subset of data in the dataset. Data entries from the subset of data are relevant to context of subject matter to be removed from the model learning for the number of machine learning models. The program instructions are executable by a computer system to label a portion of data from the subset of data. Data entries from the portion of data are associated with metric scores that indicate removal of the data will not prevent the number of machine learning models from performing tasks. The program instructions are executable by a computer system to modify the portion of data from the dataset to form an updated dataset. The portion of data from the dataset is not used for the model learning for the number of machine learning models. As a result, the illustrative embodiments provide a technical effect of efficiently performing model unlearning for the number of machine learning models by delineating data in the dataset to avoid complete retraining of the number of machine learning models from scratch.

In the illustrative embodiments, the metric scores associated with the portion of data are calculated using a set of statistical metrics using at least one of Density-Based Spatial Clustering of Applications with Noise (DBSCAN), XG-Boost, and K-means. As a result, the illustrative embodiments provide a technical effect of using the most suitable algorithms for calculating metric scores to determine if removal of data will prevent the number of machine learning models from performing tasks.

In the illustrative embodiments, the program instructions are further executable by the computer system to cause the computer system to identify a second portion of data from the subset of data. Data entries from the second portion of data are associated with metric scores that indicate removal of the data will prevent the number of machine learning models from performing tasks. The program instructions are further executable by the computer system to cause the computer system to generate pseudo representations for the second subset of data. The pseudo representations enable the number of machine learning models to perform tasks via the model learning. The program instructions are further executable by the computer system to cause the computer system to replace the second subset of data in the dataset with the pseudo representations to form the updated dataset. The program instructions are further executable by the computer system to cause the computer system to perform the model learning for the number of machine learning models using the updated dataset. As a result, the illustrative embodiments provide a technical effect of using pseudo representations to replace data in the dataset such that no data is required to be removed for model unlearning for the number of machine learning models.

In the illustrative embodiments, as part of modifying the portion of data from the dataset to form an updated dataset, the program instructions are further executable by the computer system to cause the computer system to mask the portion of data from the dataset such that the portion of data is inaccessible to the number of machine learning models during model learning. As a result, the illustrative embodiments provide a technical effect of efficiently labelling the portion of data to ensure the portion of data is inaccessible to the number of machine learning models during model learning.

In the illustrative embodiments, the context of subject matter to be removed from the model learning for the number of machine learning models is determined based on content of a user request. As a result, the illustrative embodiments provide a technical effect of providing directed model unlearning based on content of a user request.

In the illustrative embodiments, the context of subject matter to be removed from the model learning for the number of machine learning models is determined based on chronological information or security information associated with the subset of data in the dataset. As a result, the illustrative embodiments provide a technical effect of performing model unlearning for the number of machine learning models such that the number of machine learning models are able to provide up to date outputs that are in compliance with security measures. For example, if the subset of data in the dataset includes update associated with personnel changes within an organization and thereby revoking access to internal system of the organization for certain employees, the model learning for the number of machine learning models can be used to ensure that certain employees no longer have access to the internal system of the organization.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one or more storage media (also called "mediums") collectively included in a set of one or more storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

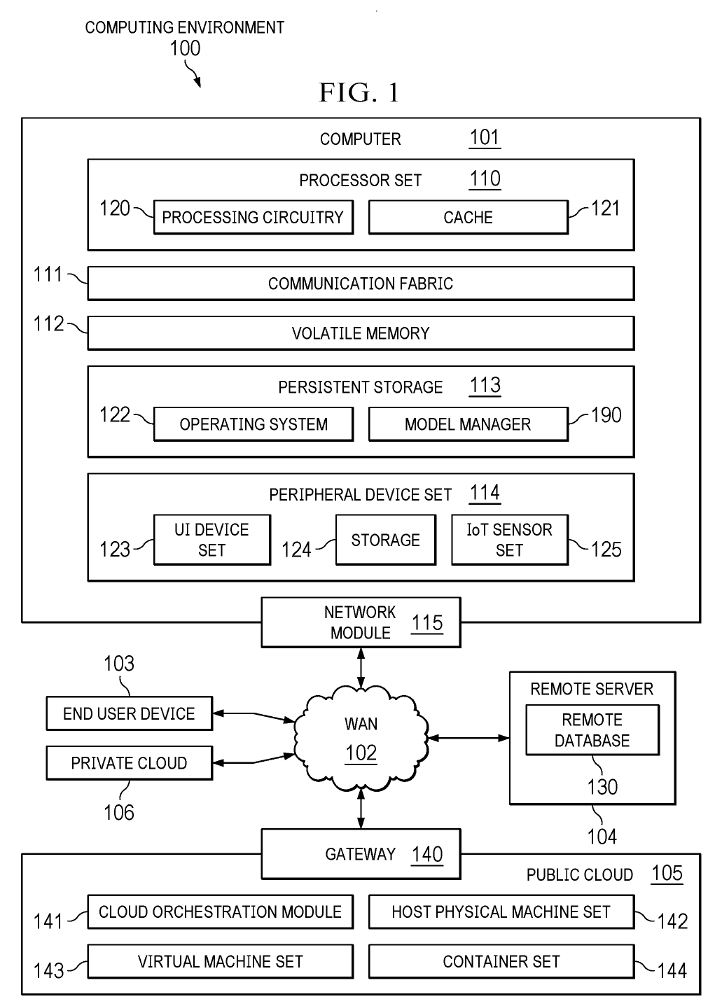

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as model manager 190. In addition to model manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer bis not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in model manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in model manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that implementing model unlearning can be difficult as machine learning models typically store information in complex, interconnected ways. Simply deleting data from the training dataset does not guarantee that the learned pattern is forgotten.

The illustrative embodiments also recognize and take into account that retraining machine learning models from scratch is challenging due to the resource-intensive processes. In addition, the illustrative embodiments also recognize and take into account that there is no universal standard for performing machine unlearning and measure on model metrics, which leads to a lack of transparency across different tools.

In addition, the illustrative embodiments also recognize and take into account that model unlearning plays a crucial role in improving the security of artificial intelligence systems by enabling selective removal of sensitive or harmful data, which helps to prevent unauthorized access, reduce vulnerabilities, and ensure compliance with privacy regulations.

Thus, illustrative embodiments of the present invention provide a computer implemented method, computer system, and computer program product for model unlearning. A processor set identifies a dataset for model learning for a number of machine learning models. The processor set delineates a subset of data in the dataset. Data entries from the subset of data are relevant to context of subject matter to be removed from the model learning for the number of machine learning models. The processor set labels a portion of data from the subset of data. Data entries from the portion of data are associated with metric scores that indicate removal of the data will not prevent the number of machine learning models from performing tasks. The processor set modifies the portion of data from the dataset to form an updated dataset. The portion of data from the dataset is not used for the model learning for the number of machine learning models.

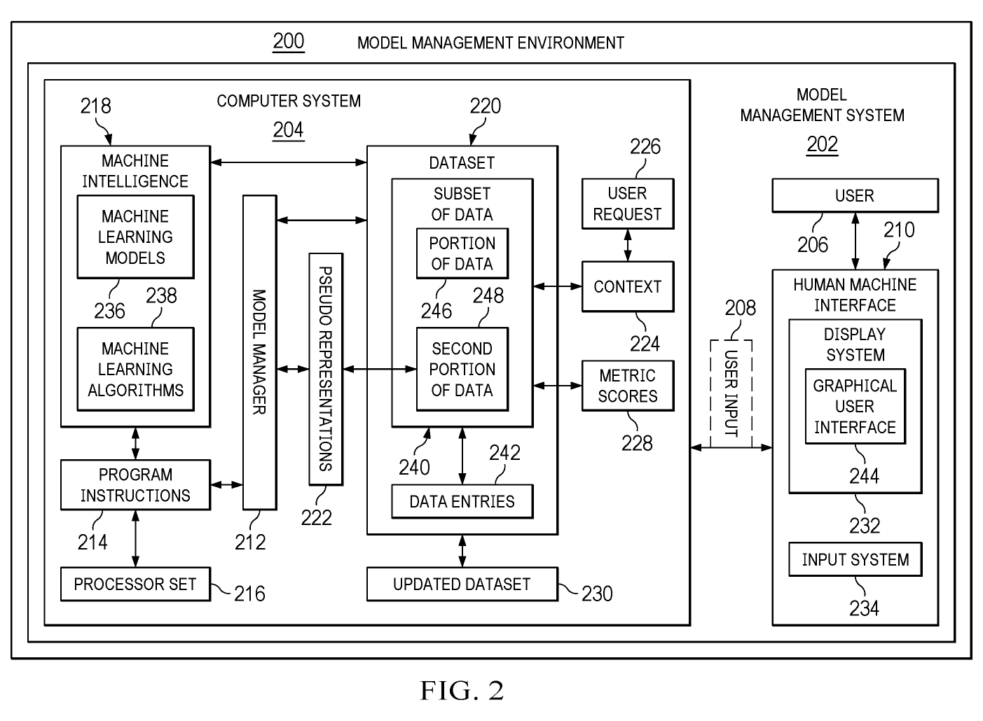

With reference now to FIG. 2, an illustration of a block diagram of a model management environment is depicted in accordance with an illustrative embodiment. In this illustrative example, model management environment 200 includes components that can be implemented in hardware such as the hardware shown in computing environment 100 in FIG. 1.

In this illustrative example, model management system 202 in model management environment 200 can be used for managing a number of machine learning models 236 for model unlearning by delineating subset of data 240. In this illustrative example, model management system 202 includes computer system 204 which includes model manager 212. Model manager 212 is located in computer system 204. Model manager 212 may be implemented using model manager 190 in FIG. 1.

Model manager 212 can be implemented in software, hardware, firmware, or a combination thereof. When software is used, the operations performed by model manager 212 can be implemented in program instructions configured to run on hardware, such as a processor unit. When firmware is used, the operations performed by model manager 212 can be implemented in program instructions and data and stored in persistent memory to run on a processor unit. When hardware is employed, the hardware can include circuits that operate to perform the operations in model manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include the number of machine learning models 236 and machine learning algorithms 238. The number of machine learning models 236 is a branch of artificial intelligence (AI) that enables computers to detect patterns and improve performance without direct programming commands. Rather than relying on direct input commands to complete a task, the number of machine learning models 236 relies on input data. The data is fed into the machine, one of machine learning algorithms 238 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning, unsupervised machine learning, or semi-supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems.

Machine learning models 236 involves using machine learning algorithms 238 to build computation models based on samples of data. The samples of data used for training are referred to as training data or training datasets. In this illustrative example, dataset 220 or a portion of dataset 220 can be used as training data for machine learning. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 238 can include supervised machine learning algorithms and unsupervised machine learning algorithms. Supervised machine learning can train machine learning models using data containing both the inputs and desired outputs. Examples of machine learning algorithms include Gradient Boosting algorithm, XGBoost, K-means clustering, and Random Forest algorithm.

In this illustrative example, machine learning models 236 can be retrained or updated using new data or outputs generated by machine learning models 236 such that parameters in machine learning algorithms 238 selected for machine learning models 236 can be adjusted to improve accuracy and efficiency of machine learning models 236.

As depicted, computer system 204 includes dataset 220 that contains data entries 242 for model learning and generation of outputs for the number of machine learning models 236. In other words, the number of machine learning models 236 can be trained using dataset 220 during the model learning process. Dataset 220 can be stored in a database that is not shown in FIG. 2. In this illustrative example, the database can be a database in computer system 204 or an artificial intelligence database which is part of machine intelligence 218.

In this illustrative example, model learning refers to the process by which a machine learning model from the number of machine learning models 236 discovers patterns, relationships, and representations from dataset 220. Model learning involves adjusting internal parameters of the model based on dataset 220 so that it can generate accurate predictions and outputs.

On the other hand, model unlearning refers to the process of selectively removing the influence of specific data from the number of machine learning models 236 after training. In other words, unlike standard model updates that add or refine knowledge, model unlearning focuses on erasing learned patterns associated with certain data points from dataset 220.

In this illustrative example, model manager 212 can delineate subset of data 240 from dataset 220. Delineation refers to a process of describing data entries in dataset 220 to make them more understandable, structured, and useful for analysis. In this example, model manager 212 can delineate subset of data 240 from dataset 220 in a number of ways. For example, model manager 212 can delineate subset of data 240 by defining, distinguishing, organizing, categorizing, segmenting, masking, and labeling subset of data 240.

In this illustrative example, data entries from subset of data 240 are relevant to context 224, which include subject matter to be removed from model learning for the number of machine learning models 236. In other words, data entries from subset of data 240 are specific types of information, topic, or patterns that need to be erased from knowledge or decision-making processes for the number of machine learning models 236. In this example, context 224 can include subject matter that is determined based on user request 226 provided by a user such as user 206.

In an alternative example, context 224 can include subject matter that is determined based on chronological information or security information associated with data entries from subset of data 240. For example, if a security update indicates that certain data entries from subset of data 240 have become highly confidential, model manager 212 can label those data entries such that they are not accessible to everybody. In another example, if certain data entries from subset of data 240 have become outdated by new data entries, model manager 212 can label those data entries such that the outdated data entries are not used for model learning or prediction making.

In addition, model manager 212 can label portion of data 246 from subset of data 240. In this example, portion of data 246 contains data entries that are associated with metric scores from metric scores 228 that indicate removal of portion of data 246 from model learning for the number of machine learning models 236 will not prevent the number of machine learning models 236 from performing intended tasks. Metric scores 228 are scores for subset of data 240 that are used to determine whether removal of data will not prevent the number of machine learning models 236 from performing tasks.

In this example, metric scores 228 can be determined using a set of statistical metrics calculated using at least one of Density-Based Spatial Clustering of Applications with Noise (DBSCAN), XG-Boost, K-means, and any suitable statistical techniques.

In this illustrative example, model manager 212 can modify portion of data 246 from subset of data 240 in dataset 220 to form updated dataset 230. In this example, portion of data 246 can be modified in a manner that portion of data 246 is no longer used for the model learning for the number of machine learning models 236 during training or retraining. Subsequently, the number of machine learning models 236 can be retrained using updated dataset 230. In this illustrative example, the retraining of the number of machine learning models 236 can be either a complete retrain using updated dataset 230, or a partial retrain that selectively adjusts the parameters, weights, or layers that are associated with subset of data 240.

In this example, portion of data 246 from subset of data 240 in dataset 220 can be modified in a number of ways. For example, model manager 212 can mask portion of data 246 from subset of data 240 in dataset 220 such that portion of data 246 is inaccessible to the number of machine learning models 236 during model learning.

In this illustrative example, model manager 212 can also identify second portion of data 248 from subset of data 240. Second portion of data 248 contains data entries that are associated with metric scores from metric scores 228 that indicate removal of second portion of data 248 will prevent the number of machine learning models 236 from performing intended tasks. In this illustrative example, model manager 212 can generate pseudo representations 222 for second portion of data 248. Pseudo representations 222 are transformed versions of real data that maintain essential characteristics but do not directly expose the original data. In other words, model learning for the number of machine learning models 236 that exclude second portion of data 248 will disable the number of machine learning models 236 from performing intended tasks while model learning for the number of machine learning models 236 that include pseudo representations 222 for second portion of data 248 enables the number of machine learning models 236 to perform intended tasks.

In this illustrative example, model manager 212 can replace second portion of data 248 with pseudo representations 222 for generating updated dataset 230. As a result, model learning can be performed and the number of machine learning models 236 can be retrained without loss of the capabilities to perform tasks. In other words, training for the number of machine learning models 236 using pseudo representations 222 instead of second portion of data 248 enables the number of machine learning models 236 to generate outputs that are not impacted by second portion of data 248.

In this illustrative example, user 206 can interact with computer system 204 through user inputs to computer system 204. For example, computer system 204 can receive user input 208 that includes content for user request 226. In an alternative example, computer system 204 can receive user input 208 that includes modifications for portion of data 246.

In this illustrative example, user input 208 can be generated by user 206 using human machine interface (HMI) 210. As depicted, human machine interface 210 includes display system 232 and input system 234. Display system 232 is a physical hardware system and includes one or more display devices on which graphical user interface 244 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 244 through user input 208 generated by input system 234. Input system 234 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view dataset 220, subset of data 240, data entries 242, user request 226, and updated dataset 230 through graphical user interface 244.

In one illustrative example, one or more solutions are present that overcome a problem with performing model unlearning without retraining machine learning models from scratch. Specifically, such unlearning process can be achieved by delineating data entries to ensure those data entries are not used during model learning without deleting any information. As a result, one or more technical solutions may provide an ability to increase efficiency and performance in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which model manager 212 in computer system 204 enables targeted removal of data from model learning without full retraining. In particular, model manager 212 transforms computer system 204 into a special purpose computer system as compared to currently available general computer systems that do not have model manager 212. In this example, model unlearning performed by model manager 212 can lead to improved speed, resource utilization, security, and compliance in AI-driven applications.

In the illustrative example, the use of model manager 212 in computer system 204 integrates processes into a practical application for targeted removal of data from model learning without full retraining. In other words, model manager 212 in computer system 204 is directed to a practical application of processes integrated into model manager 212 in computer system 204 that supports targeted removal of data from model learning without full retraining.

For example, instead of retraining models from scratch, efficient unlearning methods modify only necessary parts of the model, leading to faster updates and less downtime. In addition, removing data that was either maliciously inserted or led to biased outcomes helps maintain the integrity of AI-driven applications, which is crucial in industries like finance, where models must remain transparent and fair.

In another example, efficient model unlearning allows selective updates, lowering memory requirements and making better use of available hardware resources while traditional full retraining consumes significant storage and memory to retain and process large datasets. By avoiding unnecessary full retraining, model unlearning performed by model manager 212 reduces GPU/TPU workloads that leads to lower energy consumption and increased sustainability for large-scale AI systems.

The illustration of model management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, dataset 220 can be organized and stored in any form of data structures such as tables, lists, arrays, trees, or any suitable data structure.

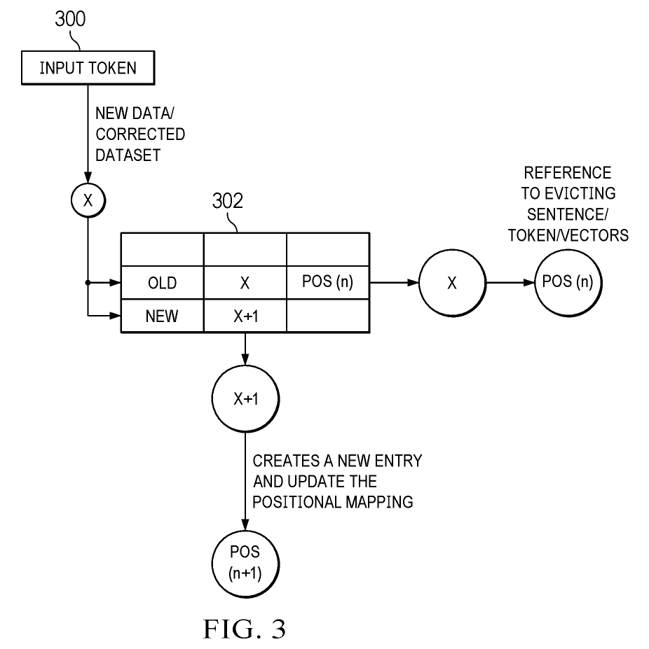

With reference now to FIG. 3, an illustration of positional mapping is shown in accordance with an illustrative embodiment. In this illustrative example, the positional mapping of data entries in table 302 can be implemented using model manager 212 in FIG. 2 and data entries from table 302 can be examples of data entries 242 in FIG. 2.

In FIG. 3, input token 300 contains new information or corrected information for updating data entry “x” in table 302. As depicted in FIG. 3, instead of deleting old data entry “x” from the middle row of table 302, a new row can be created for a new data entry that includes information of old data entry “x” and information from input token 300. In other words, the middle row of table 302 shows old data entry “x” and the newly added bottom row of table 302 shows the new data entry of “x+1” that contains updated information for old data entry “x” based on input token 300.

In table 302, a column for positional mapping of data entries “x” and “x+1” are used to track order of sequences for data entries. In this example, positional mapping refers to the process of assigning positions or coordinates to elements in a structured way. By such a method, positional mapping can be used for excluding certain information from model learning of machine learning models or marking data entries for other purposes.

In FIG. 3, the rightmost column in table 302 shows the order of sequences for data entries “x” and “x+1” based on chronological information for data entries “x” and “x+1”. In other words, table 302 presents the order of when data entries are added to table 302 using the positional mapping. For example, data entry “x” on the middle row of table 302 is associated with a positional mapping of “pos(n)”. In this example, the positional mapping is updated when data entry “x+1” is added to table 302. In this illustrative example, positional mapping for data entry “x+1” can be “pos(n+1)”, which indicate that data entry “x+1” is added later than data entry “x”.

The illustration of positional mapping in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, table 302 can include positional mappings for multiple data entries. In this example, the positional mappings for three data entries can be “pos(n-1)”, “pos(n)”, and “pos(n+1)”, which can be used to indicate that data entries are an old data entry, current data entry, and new data entry, respectively. In another example, the positional mapping of data entries can be stored separately to table 302, along with other features for data entries in table 302.

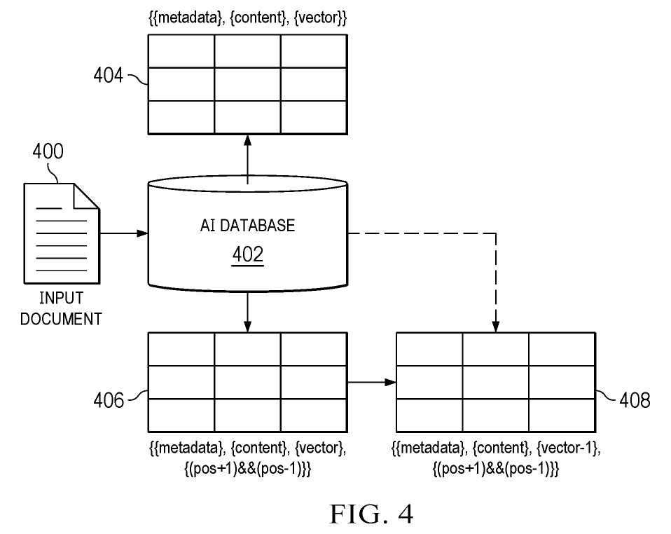

With reference now to FIG. 4, an illustration of modification of data is shown in accordance with an illustrative embodiment. In this illustrative example, the delineation of data in artificial intelligence database 402 can be implemented using model manager 212 in FIG. 2 and data entries from table 404, table 406, and table 408 can be examples of data entries 242 in FIG. 2.

In FIG. 4, input document 400 contains new information or corrected information for updating table 404 in artificial intelligence database 402. As depicted in FIG. 4, table 404 is associated with features for data entries in table 404. In this illustrative example, the features can include metadata for data entries in table 404, contents for data entries in table 404, and vectors as the numerical representations for the contents of data entries in table 404.

In this illustrative example, positional mapping for data entries can be updated based on new information from input document 400. For example, “pos+1” and “pos-1” can be added to the features for data entries in the table to indicate that some data entries are no longer relevant because of the additional content from input document 400, as illustrated in table 406. In this illustrative example, “pos+1” and “pos-1” can be used to indicate the location of irrelevant data entries in table 406, or other suitable attributes for data entries in table 406 for distinctions.

In addition, table 408 shows a modification of features for data entries to indicate that certain data entries are excluded from model learning for machine learning models based on data in artificial intelligence database 402. In this illustrative example, the data entries to be excluded from model learning can be the irrelevant data entries depicted above.

In this illustrative example, the positional mappings for data entries to be excluded from model learning is strikethrough and the metadata feature is updated with “+1” to indicate that status for those data entries are changed because they are no longer considered during model learning. In this illustrative example, features of content and vector are also updated with “-1” to indicate that content and vector for data entries to be excluded from model learning are not used for the model learning. As a result, model learning can be performed using relevant data entries from artificial intelligence database 402 without deleting any information.

The illustration of modification of data in FIG. 4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, features such as “metadata”, “content”, “vector”, and “positional mapping” can be included as part of tables such as table 404, table 406, and table 408.

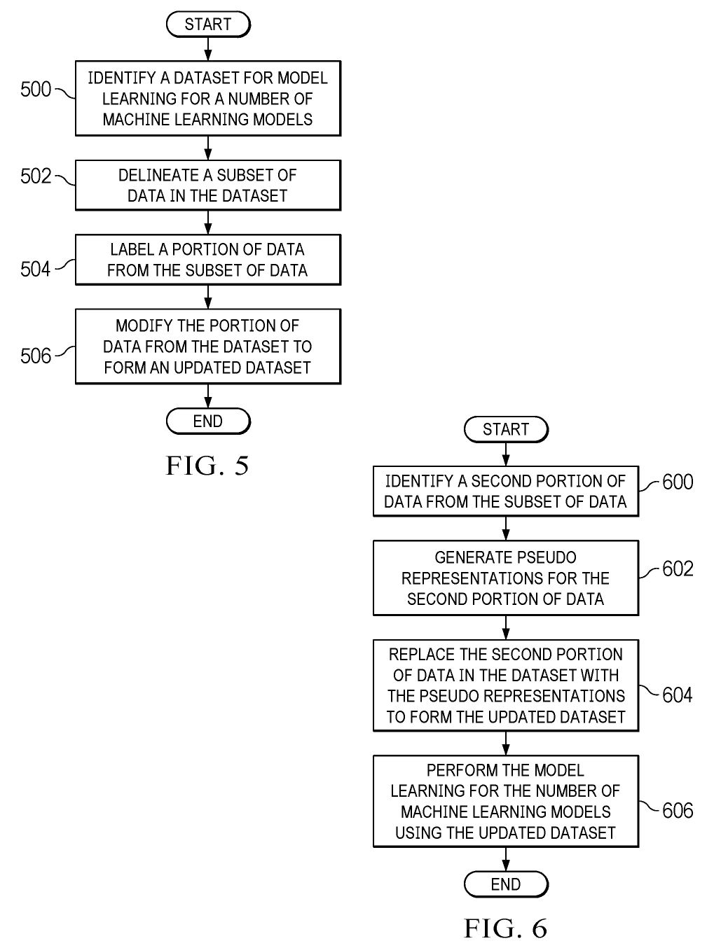

With reference now to FIG. 5, a flowchart illustrating a process for model unlearning is depicted in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in model manager 212 in computer system 204 in FIG. 2.

The process begins by identifying a dataset for model learning for a number of machine learning models (step 500). The process delineates a subset of data in the dataset (step 502). In step 502, data entries from the subset of data are relevant to the context of the subject matter to be removed from the model learning for the number of machine learning models.

The process labels a portion of data from the subset of data (step 504). In step 504, data entries from the portion of data are associated with metric scores that indicate removal of the data will not prevent the number of machine learning models from performing tasks. The process modifies the portion of data from the dataset to form an updated dataset (step 506). In step 506, the portion of data from the dataset is not used for model learning for the number of machine learning models. The process terminates thereafter.

With reference now to FIG. 6, a flowchart illustrating a process for model learning using an updated dataset is shown in accordance with an illustrative embodiment. The process in this figure is an example of an additional step that can be performed with the steps in FIG. 5.

The process begins by identifying a second portion of data from the subset of data (step 600). In this step, data entries from the second portion of data are associated with metric scores that indicate removal of the data will prevent the number of machine learning models from performing tasks. The process generates pseudo representations for the second portion of data (step 602). In step 602, the pseudo representations enable the number of machine learning models to perform tasks via the model learning.

The process replaces the second portion of data in the dataset with the pseudo representations to form the updated dataset (step 604). The process performs the model learning for the number of machine learning models using the updated dataset (step 606). The process terminates thereafter.

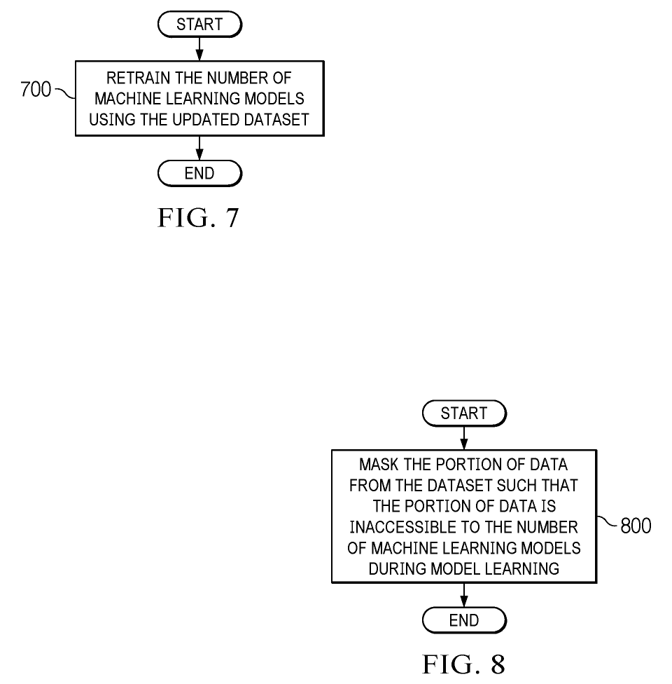

With reference now to FIG. 7, a flowchart illustrating a process for retraining machine learning models is shown in accordance with an illustrative embodiment. The process in this figure is an example of an additional step that can be performed with the steps in FIG. 5.

The process begins by retraining the number of machine learning models using the updated dataset (step 700). The process terminates thereafter.

With reference now to FIG. 8, a flowchart illustrating a process for masking data is shown in accordance with an illustrative embodiment. The process in this flowchart is an example of an implementation for step 506 in FIG. 5.

The process begins by masking the portion of data from the dataset such that the portion of data is inaccessible to the number of machine learning models during model learning (step 800). The process terminates thereafter.

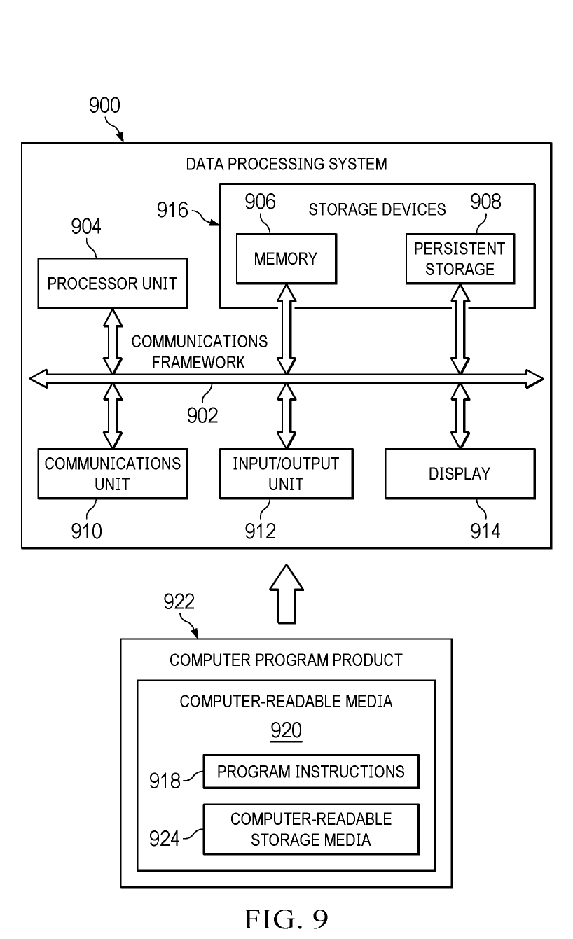

Turning now to FIG. 9, a block diagram of a data processing system is depicted in accordance with an illustrative embodiment. Data processing system 900 can be used to implement computers and computing devices in computing environment 100 in FIG. 1. Data processing system 900 can also be used to implement computer system 204 in FIG. 2. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 916 may also be referred to as computer-readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are referred to as program instructions, computer usable program instructions, or computer-readable program instructions that can be read and executed by a processor in processor unit 904. The program instructions in the different embodiments can be embodied on different physical or computer-readable storage media, such as memory 906 or persistent storage 908.

Program instructions 918 are located in a functional form on computer- readable media 920 that is selectively removable and can be loaded onto or transferred to data processing system 900 for execution by processor unit 904. Program instructions 918 and computer-readable media 920 form computer program product 922 in these illustrative examples. In the illustrative example, computer-readable media 920 is computer-readable storage media 924.

Computer-readable storage media 924 is a physical or tangible storage device used to store program instructions 918 rather than a medium that propagates or transmits program instructions 918. Computer-readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 918 can be transferred to data processing system 900 using a computer-readable signal media. The computer-readable signal media are signals and can be, for example, a propagated data signal containing program instructions 918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 920” can be singular or plural. For example, program instructions 918 can be located in computer-readable media 920 in the form of a single storage device or system. In another example, program instructions 918 can be located in computer-readable media 920 that is distributed in multiple data processing systems. In other words, some instructions in program instructions 918 can be located in one data processing system while other instructions in program instructions 918 can be located in one data processing system. For example, a portion of program instructions 918 can be located in computer-readable media 920 in a server computer while another portion of program instructions 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program instructions 918.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method comprising:
identifying, by a processor set, a dataset for model learning for a number of machine learning models;
delineating, by the processor set, a subset of data in the dataset, wherein data entries from the subset of data are relevant to context of subject matter to be removed from the model learning for the number of machine learning models;
labelling, by the processor set, a portion of data from the subset of data, wherein data entries from the portion of data are associated with metric scores that indicate removal of the data will not prevent the number of machine learning models from performing tasks; and
modifying, by the processor set, the portion of data from the dataset to form an updated dataset, wherein the portion of data from the dataset is not used for the model learning for the number of machine learning models.

2. The computer implemented method of claim 1, wherein the metric scores associated with the portion of data are calculated using a set of statistical metrics using at least one of Density-Based Spatial Clustering of Applications with Noise (DBSCAN), XG-Boost, and K-means.

3. The computer implemented method of claim 1, further comprising:
identifying, by the processor set, a second portion of data from the subset of data, wherein data entries from the second portion of data are associated with metric scores that indicate removal of the data will prevent the number of machine learning models from performing tasks;
generating, by the processor set, pseudo representations for the second portion of data, wherein the pseudo representations enable the number of machine learning models to perform tasks via the model learning;
replacing, by the processor set, the second portion of data in the dataset with the pseudo representations to form the updated dataset; and
performing, by the processor set, the model learning for the number of machine learning models using the updated dataset.

4. The computer implemented method of claim 1, further comprising:
retraining, by the processor set, the number of machine learning models using the updated dataset.

5. The computer implemented method of claim 1, wherein modifying, by the processor set, the portion of data from the dataset to form an updated dataset comprises:
masking, by the processor set, the portion of data from the dataset such that the portion of data is inaccessible to the number of machine learning models during model learning.

6. The computer implemented method of claim 1, wherein the context of subject matter to be removed from the model learning for the number of machine learning models is determined based on content of a user request.

7. The computer implemented method of claim 1, wherein the context of subject matter to be removed from the model learning for the number of machine learning models is determined based on chronological information or security information associated with the subset of data in the dataset.

8. A computer system comprising:
a processor set;
a set of one or more computer-readable storage media; and
program instructions stored on the set of one or more computer-readable storage media to cause the processor set to perform operations comprising:
identifying a dataset for model learning for a number of machine learning models;
delineating a subset of data in the dataset, wherein data entries from the subset of data are relevant to context of subject matter to be removed from the model learning for the number of machine learning models;
labelling a portion of data from the subset of data, wherein data entries from the portion of data are associated with metric scores that indicate removal of the data will not prevent the number of machine learning models from performing tasks; and
modifying the portion of data from the dataset to form an updated dataset, wherein the portion of data from the dataset is not used for the model learning for the number of machine learning models.

9. The computer system of claim 8, wherein the metric scores associated with the portion of data are calculated using a set of statistical metrics using at least one of Density-Based Spatial Clustering of Applications with Noise (DBSCAN), XG-Boost, and K-means.

10. The computer system of claim 8, wherein the operations further comprise:
identifying a second portion of data from the subset of data, wherein data entries from the second portion of data are associated with metric scores that indicate removal of the data will prevent the number of machine learning models from performing tasks;
generating pseudo representations for the second portion of data, wherein the pseudo representations enable the number of machine learning models to perform tasks via the model learning;
replacing the second portion of data in the dataset with the pseudo representations to form the updated dataset; and
performing the model learning for the number of machine learning models using the updated dataset.

11. The computer system of claim 8, wherein the operations further comprise:
retraining the number of machine learning models using the updated dataset.

12. The computer system of claim 8, wherein modifying the portion of data from the dataset to form an updated dataset comprises:
masking the portion of data from the dataset such that the portion of data is inaccessible to the number of machine learning models during model learning.

13. The computer system of claim 8, wherein the context of subject matter to be removed from the model learning for the number of machine learning models is determined based on content of a user request.

14. The computer system of claim 8, wherein the context of subject matter to be removed from the model learning for the number of machine learning models is determined based on chronological information or security information associated with the subset of data in the dataset.

15. A computer program product comprising:
a set of one or more computer-readable storage media;
program instructions stored in the set of one or more computer-readable storage media to perform operations comprising:
identifying, by a processor set, a dataset for model learning for a number of machine learning models;
delineating, by the processor set, a subset of data in the dataset, wherein data entries from the subset of data are relevant to context of subject matter to be removed from the model learning for the number of machine learning models;
labelling, by the processor set, a portion of data from the subset of data, wherein data entries from the portion of data are associated with metric scores that indicate removal of the data will not prevent the number of machine learning models from performing tasks; and
modifying, by the processor set, the portion of data from the dataset to form an updated dataset, wherein the portion of data from the dataset is not used for the model learning for the number of machine learning models.

16. The computer program product of claim 15, wherein the metric scores associated with the portion of data are calculated using a set of statistical metrics using at least one of Density-Based Spatial Clustering of Applications with Noise (DBSCAN), XG-Boost, and K-means.

17. The computer program product of claim 15, wherein the operations further comprise:
identifying, by the processor set, a second portion of data from the subset of data, wherein data entries from the second portion of data are associated with metric scores that indicate removal of the data will prevent the number of machine learning models from performing tasks;
generating, by the processor set, pseudo representations for the second portion of data, wherein the pseudo representations enable the number of machine learning models to perform tasks via the model learning;
replacing, by the processor set, the second portion of data in the dataset with the pseudo representations to form the updated dataset; and
performing, by the processor set, the model learning for the number of machine learning models using the updated dataset.

18. The computer program product of claim 15, wherein modifying, by the processor set, the portion of data from the dataset to form an updated dataset comprises:
masking, by the processor set, the portion of data from the dataset such that the portion of data is inaccessible to the number of machine learning models during model learning.

19. The computer program product of claim 15, wherein the context of subject matter to be removed from the model learning for the number of machine learning models is determined based on content of a user request.

20. The computer program product of claim 15, wherein the context of subject matter to be removed from the model learning for the number of machine learning models is determined based on chronological information or security information associated with the subset of data in the dataset.
